(19) United States
(12) Patent Application Publication
(10) Pub. No.: US 2025/0087717 A1
(43) Pub. Date: Mar. 13, 2025

(54) INTEGRATED UNIT CELL FOR FUEL CELL

(71) Applicants: Hyundai Motor Company, Seoul (KR); Kia Corporation, Seoul (KR)

(72) Inventors: Byeong-Heon Jeong, Seoul (KR); Jong Hyeok Noh, Ansan-si (KR); Duk Hoon Kwon, Hwaseong-si (KR); Jin Hyeok Yoo, Yongin-si (KR); Seung Hun Han, Osan-si (KR)

(21) Appl. No.: 18/529,370

(22) Filed: Dec. 5, 2023

(30) Foreign Application Priority Data
Sep. 13, 2023 (KR) 10-2023-0121815

(51) Int. Cl. H01M 8/0267; H01M 8/0258; H01M 8/0273; H01M 8/0284; H01M 8/1004

(52) U.S. Cl. CPC H01M 8/0267; H01M 8/0258; H01M 8/0273; H01M 8/0284; H01M 8/1004; H01M 2008/1095

(57) ABSTRACT

An embodiment integrated unit cell for a fuel cell stack includes an insert constructed with a membrane electrode assembly and a pair of gas diffusion layers disposed on opposite surfaces of the membrane electrode assembly, a frame having a form of a sheet, the frame being disposed to surround a periphery of the insert in an outer boundary region of the insert and joined to any one of opposite surfaces of the periphery of the insert by a first adhesive member at an interface thereof, and a pair of separators disposed on opposite surfaces of the frame, respectively, and joined to the opposite surfaces of the frame by second adhesive members.

### CROSS-REFERENCE TO RELATED APPLICATIONS

This application claims the benefit of Korean Patent Application No. 10-2023-0121815, filed on Sep. 13, 2023, which application is hereby incorporated herein by reference.

### TECHNICAL FIELD

The present disclosure relates to an integrated unit cell for a fuel cell.

### BACKGROUND

A fuel cell, which is a type of power generation device that converts the chemical energy of fuel into electrical energy through the electrochemical reaction within a stack, can be employed to supply driving power for industrial, building, aviation, household, and vehicle applications as well as to supply power to small electronic products such as hand-held devices, and recently, its use area is gradually expanding as a highly efficient, clean energy source.

The unit cell of a typical fuel cell has a membrane electrode assembly (MEA) located at the innermost part, wherein this membrane electrode assembly is constructed with a polymer electrolyte membrane through which hydrogen ions (protons) can pass, and catalyst layers, that is, an anode and cathode, coated on opposite surfaces of this electrolyte membrane to allow hydrogen and oxygen to react therewith.

Additionally, gas diffusion layers (GDLs) are laminated on the outer sides of the membrane electrode assembly, that is, the outer sides of the anode and cathode, and separators with flow fields for supplying fuel and discharging water generated by the reaction are located at the outer sides of the gas diffusion layers.

A fuel cell stack is formed by stacking a plurality of unit cells configured as described above in series in order to generate a desired level of output from the fuel cell. In the fuel cell stack, end plates are attached to the outermost parts of the plurality of unit cells to support and secure the unit cells.

Meanwhile, conventionally, a membrane-electrode-gasket assembly (MEGA), in which a membrane electrode assembly and a gasket were integrated, was manufactured and used to maintain the airtightness of the unit cell and to facilitate the stacking process.

In addition, research has recently been conducted on an integrated frame in which an electricity-generating assembly (EGA) (or membrane-electrode-gas diffusion layer assembly), in which gas diffusion layers are joined to a membrane electrode assembly, is integrated with a gasket.

One of the results of this research is to manufacture an elastomer frame surrounding the periphery of the membrane-electrode-gasket assembly (MEGA).

However, for the elastomer frame, a sheet-shaped frame is manufactured using thermoplastic elastomers (TPEs) and then joined by hot pressing with the membrane-electrode-gasket assembly (MEGA), and at this time, there was a problem in that the membrane-electrode-gasket assembly (MEGA) was damaged or the elastomer frame was deformed due to the heat and pressure provided during the hot pressing for joining.

Further, since the elastomer frame is joined to a separator made of a metallic material by the hot pressing, a problem occurred in which the junction between the separator and the elastomer frame was not achieved at the desired level. As a result, there occurred problems related to the alignment of the unit cells when manufacturing a fuel cell stack by stacking unit cells.

Meanwhile, in the case of manufacturing and using the membrane-electrode-gasket assembly (MEGA), it is possible to reduce costs by reducing the amount of electrolyte membrane used, but when a stack was manufactured by simply stacking several component parts, cell assembly tolerances increased, and it was difficult to replace only a cell judged to be defective within the stack, and there were limits to increasing the stack productivity.

The matters described above as the background are only for facilitating a better understanding of the background of embodiments of the present disclosure and should not be taken as an acknowledgment that they correspond to the prior art already known to those of ordinary skill in the art.

### SUMMARY

The present disclosure relates to an integrated unit cell for a fuel cell. Particular embodiments relate to an integrated unit cell for a fuel cell in which an insert is integrated with separators by using a frame formed to have a three-dimensional structure.

Embodiments of the present disclosure provide an integrated unit cell for a fuel cell in which an insert is integrated with separators by using a frame formed to have a three-dimensional structure.

Technical objects, which embodiments of the present disclosure may accomplish, are not limited to the aforementioned ones, and other technical objects not mentioned above may be clearly appreciated from the description of the present disclosure by a person having ordinary skill in the art to which the present disclosure belongs.

An integrated unit cell for a fuel cell stack according to an embodiment is an integrated unit cell applied to a fuel cell stack and includes an insert constructed with a membrane electrode assembly and a pair of gas diffusion layers disposed on opposite surfaces of the membrane electrode assembly, a frame formed in the form of a sheet, disposed to surround a periphery of the insert in an outer boundary region of the insert, and joined to any one of opposite surfaces of the periphery of the insert by an adhesive member at an interface thereof, and a pair of separators disposed on opposite surfaces of the frame respectively and joined to the opposite surfaces of the frame by adhesive members.

A joint portion to which any one of the opposite surfaces of the insert is joined is formed by forming a reaction region through-hole in the frame, in which the insert is disposed, and by forming a step portion along an inner peripheral surface of the reaction region through-hole to have a level difference from a surface.

Any one of the pair of gas diffusion layers of the insert is formed to have the same size as the membrane electrode assembly, and the other one of the pair of gas diffusion layers is formed to be smaller than the membrane electrode assembly, so that a periphery of the membrane electrode assembly is exposed, and the exposed periphery is joined to the joint portion by the adhesive member.

In the center of the frame, a reaction region through-hole in which the insert is disposed is formed. On one side of the frame, a plurality of first manifold through-holes through which a first or second reaction gas flows in or is discharged are formed, and on the other side of the frame, a plurality of second manifold through-holes through which the first or second reaction gas flows in or is discharged are formed. On one surface of the frame, a first reaction gas inlet flow channel through which a reaction gas flows is formed between any one of the first manifold through-holes and the reaction region through-hole, and a first reaction gas outlet flow channel through which the first reaction gas flows is formed between the reaction region through-hole and any one of the second manifold through-holes. On the other surface of the frame, a second reaction gas inlet flow channel through which a reaction gas flows is formed between another of the second manifold through-holes and the reaction region through-hole, and a second reaction gas outlet flow channel through which the second reaction gas flows is formed between the reaction region through-hole and another of the first manifold through-holes.

Each of the pair of separators has a plurality of third manifold through-holes which are formed on one side and are in communication with the plurality of first manifold through-holes and a plurality of fourth manifold through-holes which are formed on the other side and are in communication with the second manifold through-holes.

The pair of separators includes a first separator joined to one surface of the frame and a second separator joined to the other surface of the frame, the first separator has first passage tunnels, each formed in the form of a tunnel through which the first reaction gas flows by being overlapped with the first reaction gas inlet flow channel and the first reaction gas outlet flow channel, and the second separator has second passage tunnels, each formed in the form of a tunnel through which the second reaction gas flows by being overlapped with the second reaction gas inlet flow channel and the second reaction gas outlet flow channel.

On the one surface of the frame, a first adhesive groove portion is formed in the form of a groove of a closed structure formed to surround the reaction region through-hole, the plurality of first manifold through-holes, and the plurality of second manifold through-holes. On the other surface of the frame, a second adhesive groove portion is formed in the form of a groove of a closed structure formed to surround the reaction region through-hole, the plurality of first manifold through-holes, and the plurality of second manifold through-holes, and adhesive members are disposed in the first adhesive groove portion and the second adhesive groove portion.

The first adhesive groove portion and the second adhesive groove portion are formed at locations symmetrical to each other based on the thickness direction of the frame.

The adhesive members disposed in the first adhesive groove portion and the second adhesive groove portion do not contact the insert and are disposed on the frame or the pair of separators.

The pair of separators includes a first separator joined to one surface of the frame and a second separator joined to the other surface of the frame. The first separator has a first adhesive forming portion formed toward the frame so as to overlap the first adhesive groove portion, and adherence and sealing between the first adhesive forming portion and the first adhesive groove portion are achieved by an adhesive member. The second separator has a second adhesive forming portion formed toward the frame so as to overlap the second adhesive groove portion, and adherence and sealing between the second adhesive forming portion and the second adhesive groove portion are achieved by an adhesive member.

The depths of the first reaction gas inlet flow channel and the first reaction gas outlet flow channel formed on the one surface of the frame are formed deeper than the depth of the first adhesive forming portion formed on the first separator, and the depths of the second reaction gas inlet flow channel and the second reaction gas outlet flow channel formed on the other surface of the frame are formed deeper than the depth of the second adhesive forming portion formed on the second separator.

The first adhesive forming portion and the second adhesive forming portion are formed to have widths smaller than those of the first adhesive groove portion and the second adhesive groove portion, respectively.

The first adhesive forming portion of the first separator and the second adhesive forming portion of the second separator are formed at locations that overlap each other.

Any one of the first adhesive forming portion of the first separator and the second adhesive forming portion of the second separator is provided with a gasket applied to an opposite surface to a surface on which an adhesive member is disposed to form an airtight line for sealing of a coolant.

On the one side of the frame, a first coolant manifold through-hole through which coolant flows in or is discharged is formed, and on the other side of the frame, a second coolant manifold through-hole through which coolant flows in or is discharged is formed. Each of the pair of separators has a third coolant manifold through-hole which is formed on one side and is in communication with the first coolant manifold through-holes and a fourth coolant manifold through-hole which is formed on the other side and is in communication with the second coolant manifold through-hole.

In the pair of separators, a coolant inlet flow region through which coolant flows is formed between the first coolant manifold through-hole and the reaction region through-hole, and a coolant outlet flow region through which coolant flows is formed between the reaction region through-hole and the second coolant manifold through-hole.

The pair of separators is formed such that regions where the coolant inlet flow region and the coolant outlet flow region are formed are in contact with opposite surfaces of the insert.

The size of the edge of the frame is the same as or larger than those of the pair of separators.

The frame is formed of engineering plastic or super engineering plastic with a thermal expansion coefficient of 40×10⁻⁶/° C. or less.

The frame is formed into a three-dimensional structure by injection molding, injection/compression hybrid molding, compression molding, or 3D printing forming.

According to the embodiments of the present disclosure, the following effects can be expected.

First, it has the advantage of reducing the cell assembly tolerance compared to the conventional cell structure manufactured by simply stacking the parts of a unit cell.

Second, there are advantages in that the airtightness of the reaction surface can be secured without a separate sealing member, and thus, the material cost is reduced by eliminating the need for a sealing member, and the manufacturing cost can be reduced by eliminating the sealing member molding process and the like.

Third, there is an advantage in that electrical shorts between cells can be prevented because the moisture generated in the cell reaction region can be fundamentally prevented from diffusing to the outside of the cell through the electrolyte membrane, and there is also an effect of preventing the corrosion of the outer casing of the stack due to moisture.

Fourth, since there is no need to use electrolyte membranes in regions other than the cell reaction region, there is an effect of reducing costs in terms of material costs.

Fifth, the stack production cycle time is reduced, which is advantageous for mass production of fuel cell stacks.

Sixth, the application of integrated unit cells can advantageously facilitate the replacement of a specific defective cell, which may occur during the stack manufacturing process or its operation.

### BRIEF DESCRIPTION OF THE DRAWINGS

FIG. 1 is an exploded perspective view showing an integrated unit cell for a fuel cell stack according to an embodiment of the present disclosure.

FIGS. 2A and 2B are views showing a frame of an integrated unit cell for a fuel cell stack according to an embodiment of the present disclosure.

FIG. 3 is a view showing a reaction surface of a first separator of an integrated unit cell for a fuel cell stack according to an embodiment of the present disclosure.

FIG. 4A is a view showing a reaction surface of a second separator of an integrated unit cell for a fuel cell stack according to an embodiment of the present disclosure.

FIG. 4B is a view showing a cooling surface of a second separator of an integrated unit cell for a fuel cell stack according to an embodiment of the present disclosure.

FIG. 5 is a view showing a cross section taken along line A-A in FIGS. 2A and 2B of an integrated unit cell for a fuel cell stack according to an embodiment of the present disclosure.

FIG. 6 is a view showing a cross section taken along line B-B in FIGS. 2A and 2B of an integrated unit cell for a fuel cell stack according to an embodiment of the present disclosure.

FIG. 7A is an exploded perspective view showing a region through which a reaction gas flows in an integrated unit cell for a fuel cell stack according to an embodiment of the present disclosure.

FIG. 7B is a view showing a cross section of a region in FIG. 7A where the first reaction gas outlet flow channel is formed.

FIG. 8A is an exploded perspective view showing a region through which a reaction gas flows in an integrated unit cell for a fuel cell stack according to another embodiment of the present disclosure.

FIG. 8B is a view showing a cross section of a region in FIG. 8A where the first reaction gas outlet flow channel is formed.

FIG. 9 is a view showing a region through which a first reaction gas flows in an integrated unit cell for a fuel cell stack according to an embodiment of the present disclosure.

### DETAILED DESCRIPTION OF ILLUSTRATIVE EMBODIMENTS

Hereinafter, exemplary embodiments disclosed herein will be described with reference to the accompanying drawings, in which identical or like components are given like reference numerals regardless of drawing numbers, and description thereof will not be repeated.

Suffixes for components, e.g., “module”, “unit”, “portion”, and “part”, used in the following description will be given or used in place of each other taking only easiness of specification drafting into consideration, and they do not have distinguishable meanings or roles by themselves.

In describing the embodiments disclosed herein, it is noted that the detailed description for related known arts may be omitted herein so as not to obscure essential points of embodiments of the disclosure. Further, the accompanying drawings are intended to facilitate a better understanding of the examples disclosed herein, and the technical spirit disclosed herein is not limited by the accompanying drawings and rather should be construed as including all the modifications, equivalents, and substitutes within the technical idea and technical scope of embodiments of the disclosure.

The terms including ordinal numbers such as first, second, and the like may be used to explain various components, but the components should not be limited by these terms. The above-mentioned terms are used in order only to distinguish one component from another component.

Further, when one component is referred to as being “connected to” or “coupled to” another element, it should be understood as that the one component may be directly connected or coupled to that other component, or any intervening component may also be present therebetween. Contrarily, when one component is referred to as being “directly connected” or “directly coupled” to another component, it should be understood as that no other element is present therebetween.

The singular form may include the plural form unless the context clearly indicates otherwise.

Terms such as “include (or comprise)”, “have (or be provided with)”, and the like are intended to indicate that features, numbers, steps, operations, components, parts, or combinations thereof written in the following description exist, and thus should not be understood to indicate that the possibility of existence or addition of one or more different features, numbers, steps, operations, components, parts, or combinations thereof is excluded in advance.

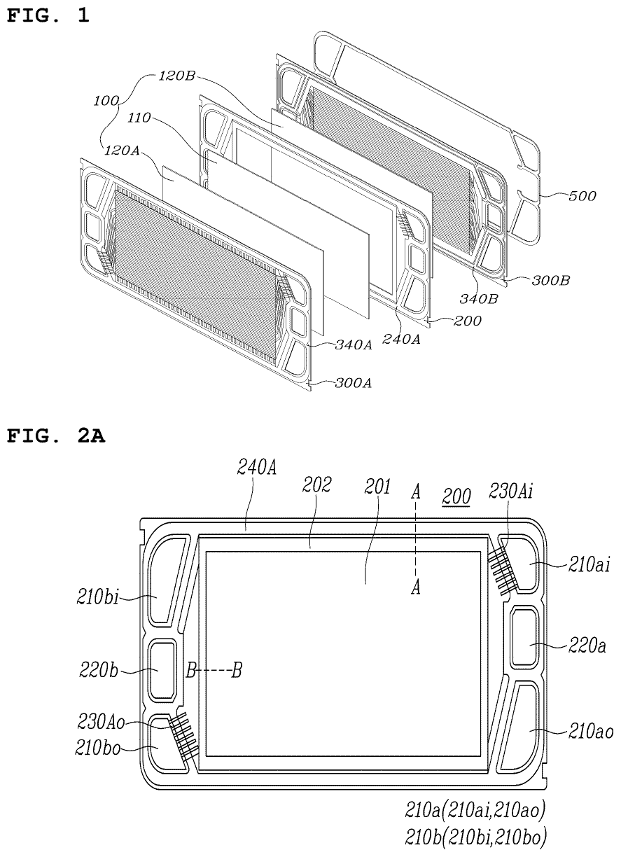

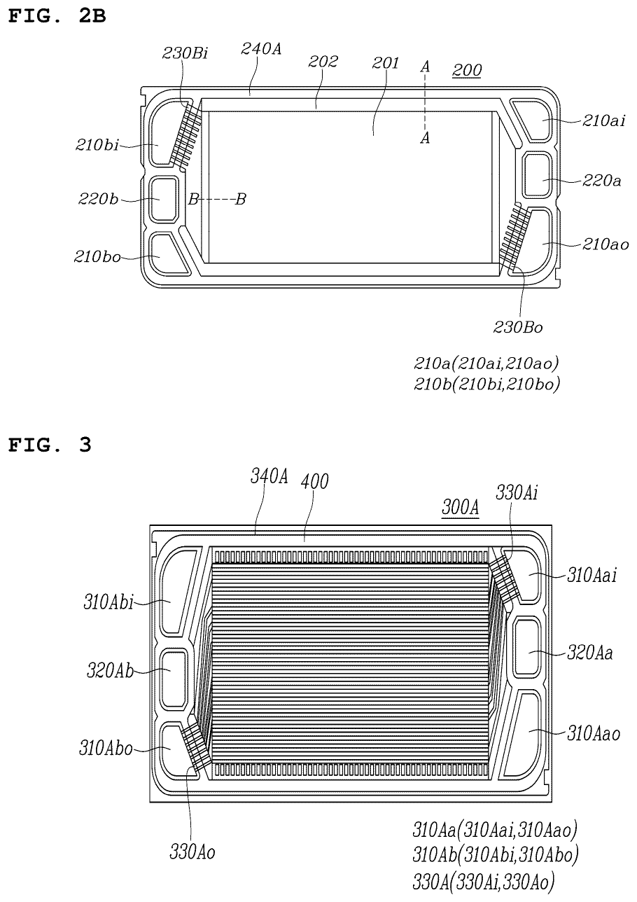

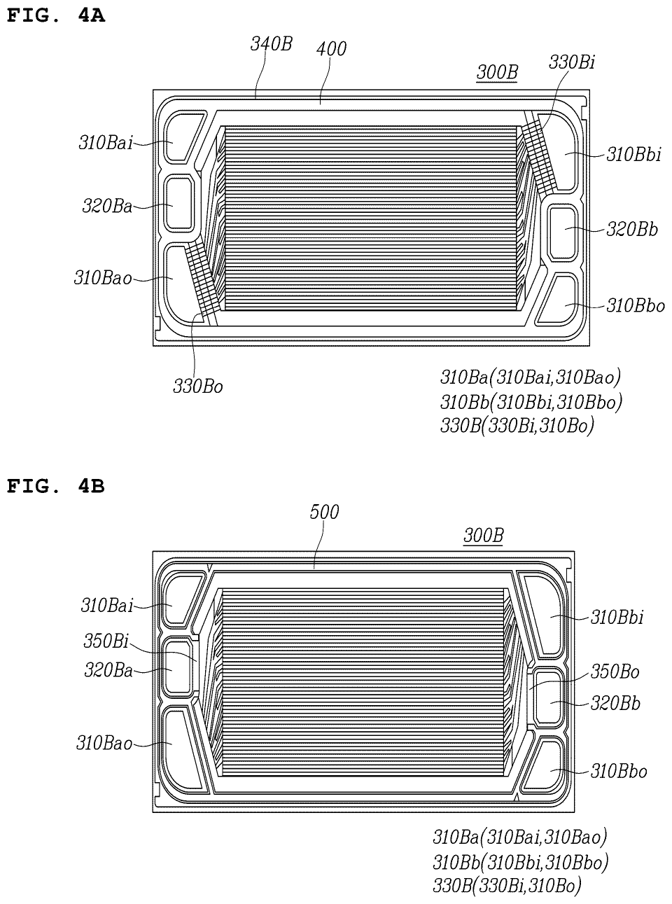

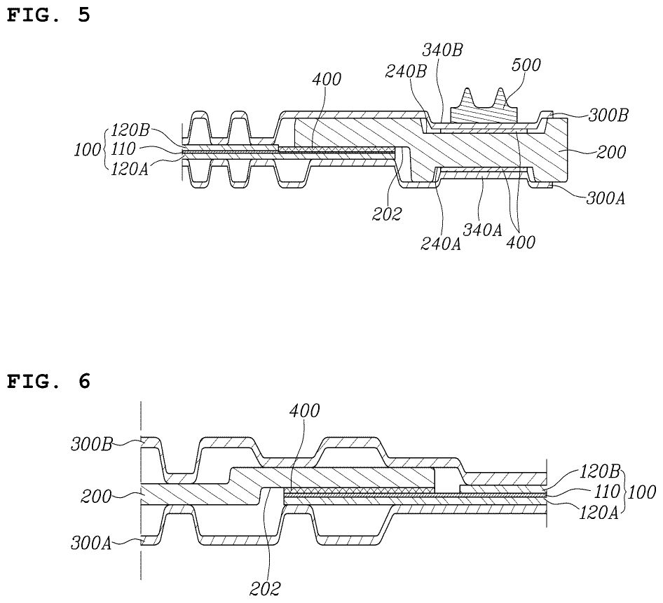

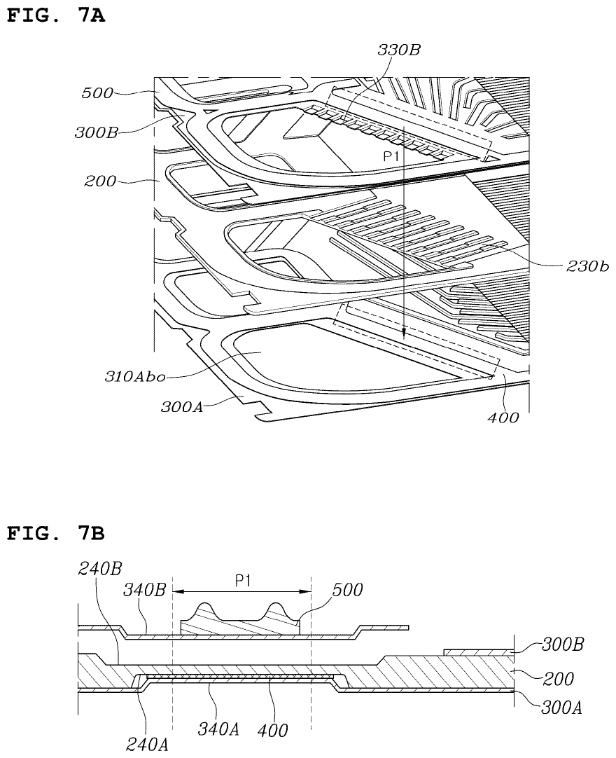

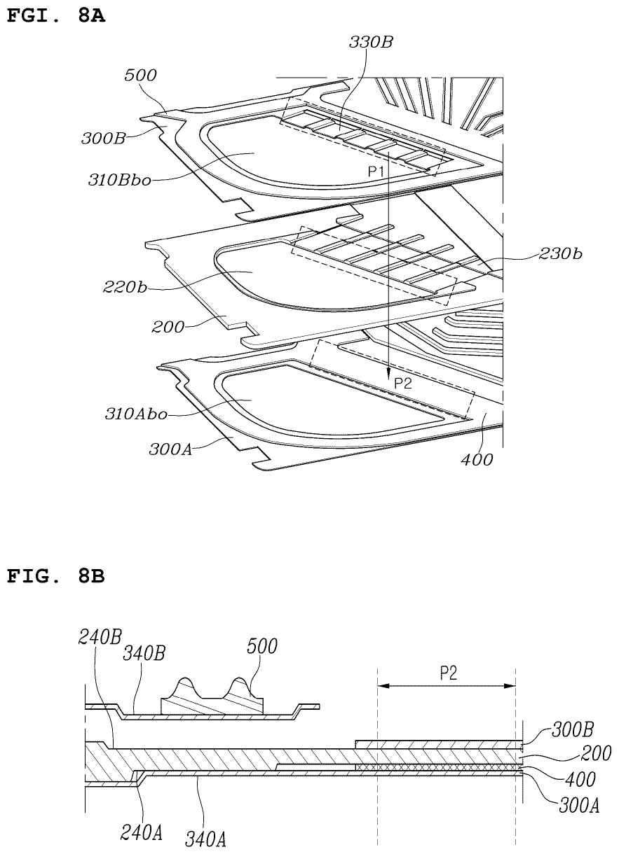

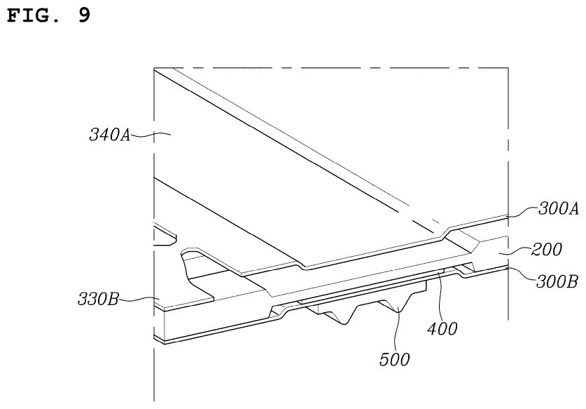

FIG. 1 is an exploded perspective view showing an integrated unit cell for a fuel cell stack according to an embodiment of the present disclosure, FIGS. 2A and 2B are views showing a frame of an integrated unit cell for a fuel cell stack according to an embodiment of the present disclosure, FIG. 3 is a view showing a reaction surface of a first separator of an integrated unit cell for a fuel cell stack according to an embodiment of the present disclosure, FIG. 4A is a view showing a reaction surface of a second separator of an integrated unit cell for a fuel cell stack according to an embodiment of the present disclosure, FIG. 4B is a view showing a cooling surface of a second separator of an integrated unit cell for a fuel cell stack according to an embodiment of the present disclosure, FIG. 5 is a view showing a cross section taken along line A-A in FIGS. 2A and 2B of an integrated unit cell for a fuel cell stack according to an embodiment of the present disclosure, FIG. 6 is a view showing a cross section taken along line B-B in FIGS. 2A and 2B of an integrated unit cell for a fuel cell stack according to an embodiment of the present disclosure, FIG. 7A is an exploded perspective view showing a region through which a reaction gas flows in an integrated unit cell for a fuel cell stack according to an embodiment of the present disclosure, FIG. 7B is a view showing a cross section of a region in FIG. 7A where the first reaction gas outlet flow channel is formed, FIG. 8A is an exploded perspective view showing a region through which a reaction gas flows in an integrated unit cell for a fuel cell stack according to another embodiment of the present disclosure, FIG. 8B is a view showing a cross section of a region in FIG. 8A where the first reaction gas outlet flow channel is formed, and FIG. 9 is a view showing a region through which a first reaction gas flows in an integrated unit cell for a fuel cell stack according to an embodiment of the present disclosure.

As shown in the drawings, an integrated unit cell for a fuel cell stack according to an embodiment of the present disclosure is an integrated unit cell applied to a fuel cell stack and includes an insert 100 constructed with a membrane electrode assembly 110 and a pair of gas diffusion layers 120A, 120B disposed on opposite sides thereof, a frame 200 joined to any one of opposite surfaces of the periphery of the insert 100 in the outer boundary of the insert 100 by an adhesive member 400 at the interface therebetween, and a pair of separators 300A, 300B disposed on the opposite surfaces of the frame 200, respectively, and joined to the opposite surfaces of the frame 200 by the adhesive member 400, respectively.

The insert 100 is an assembly of the membrane electrode assembly 110 and a pair of gas diffusion layers 120A and 120B, and preferably, the gas diffusion layers 120A and 120B are disposed and stacked on one surface and the other surface of the membrane electrode assembly 110, respectively.

In this regard, the membrane electrode assembly 110 is constructed with a polymer electrolyte membrane through which hydrogen ions (protons) pass, and catalyst layers, i.e., a first electrode layer and a second electrode layer, which are coated on opposite surfaces of this polymer electrolyte membrane so that the reaction gases, hydrogen and oxygen, can react therewith. At this time, the first electrode layer may be an anode and the second electrode layer may be a cathode. Of course, without being limited to the foregoing, the first electrode layer may be a cathode and the second electrode layer may be an anode. In this regard, the first electrode layer and the second electrode layer may be formed to have the same size as the polymer electrolyte membrane. However, for the first and second electrode layers to be securely joined to the polymer electrolyte membrane and the frame 200, it is preferable that one of the first electrode layer and the second electrode layer is formed to have the same size as the polymer electrolyte membrane, and the other one of the first electrode layer and the second electrode layer is formed to be slightly smaller than the polymer electrolyte membrane. For example, the first electrode layer may be formed to have the same size as the polymer electrolyte membrane, and the second electrode layer may be formed to be slightly smaller than the polymer electrolyte membrane.

Meanwhile, in this embodiment, hydrogen is referred to as the first reaction gas, and air containing oxygen is referred to as the second reaction gas.

The gas diffusion layers 120A, 120B allow the first reaction gas or the second reaction gas flowing through the separators 300A, 300B to pass through itself while diffusing the first or second reaction gas to the membrane electrode assembly 110, and the pair of gas diffusion layers 120A, 120B of the insert 100 are distinguished into a first gas diffusion layer 120A facing the first electrode layer of the membrane electrode assembly 110 and a second gas diffusion layer 120B facing the second electrode layer of the membrane electrode assembly 110. In this regard, the first gas diffusion layer 120A and the second gas diffusion layer 120B may be formed to have the same size as the membrane electrode assembly. However, for the first gas diffusion layer 120A and the second gas diffusion layer 120B to be securely joined to the membrane electrode assembly 110 and the frame 200, it is preferable that one of the first gas diffusion layer 120A and the second gas diffusion layer 120B is formed to have the same size as the membrane electrode assembly 110, and the other one of the first gas diffusion layer 120A and the second gas diffusion layer 120B is formed to be slightly smaller than the membrane electrode assembly 110. For example, the first gas diffusion layer 120A is formed to have the same size as the membrane electrode assembly 110, and the second gas diffusion layer 120B is formed to be slightly smaller than the membrane electrode assembly 110.

Therefore, along the periphery of the insert 100, the first gas diffusion layer 120A is exposed to one side, and the periphery of the membrane electrode assembly 110 is exposed to the other side.

The frame 200 is formed integrally with the outer region of the insert 100 to serve as a way of maintaining the airtightness of the insert 100 and facilitate the lamination process, and the frame 200 is manufactured in a predetermined 3D shape and is joined to the insert and the pair of separators by the separate adhesive member 400. In this regard, the frame 200 is preferably made of a hard plastic material that has a similar thermal expansion coefficient to those of the separators 300A and 300B made of a metal material. For example, the plastic material applied to the frame 200 may be formed of engineering plastic or super engineering plastic having a thermal expansion coefficient of 40×10⁻⁶/° C. or less.

Meanwhile, the frame 200 is preferably molded into a three-dimensional structure by a manufacturing method such as injection molding, injection/compression hybrid molding, compression molding, 3D printing forming, or the like.

And, the adhesive member 400 may employ an adhesive or an adhesive sheet.

Meanwhile, the frame 200 is disposed to face any one of the opposite surfaces of the periphery of the insert 100 in the outer boundary region of the insert 100. At this time, the frame 200 is disposed to face the other surface of the opposite surfaces of the periphery of the insert 100, that is, a site where the edge of the membrane electrode assembly 110 is exposed. Therefore, the frame 200 is joined with the edge of the membrane electrode assembly 110 of the insert 100 by the adhesive member 400.

Here, the term ‘outer boundary region’ of the insert 100 refers to a region including the edge region of the insert 100 and the surrounding space, and the term ‘periphery’ of the insert 100 refers to the edge region of the insert 100.

The frame 200 is disposed to face the other surface of the periphery of the insert 100 and surround the outer boundary region of the insert 100. In particular, the frame 200 may be provided with a region which faces the insert 100 to be joined tightly to the insert.

For example, a joint portion 202 to which the other surface of the opposite surfaces of the insert 100 is joined is formed by forming a reaction region through-hole 201 in the center of the frame 200, in which the insert 100 is disposed, and by forming a step portion along the inner peripheral surface of the reaction region through-hole 201 to have a level difference from the surface in the direction of one of the opposite surfaces of the frame 200.

Accordingly, the joint portion 202 of the frame 200 faces and is joined to the exposed site of the membrane electrode assembly 110 at the periphery of the insert 100 by the adhesive member 400 to achieve a strong junction and integration with each other.

Additionally, the frame 200 is provided with a plurality of manifold through-holes formed therein for forming a manifold that introduces and discharges reaction gas and cooling water into and from the reaction region formed by the insert 100, that is, the membrane electrode assembly 110 and the gas diffusion layers 120A, 120B.

For example, in the center of the frame 200, the reaction region through-hole 201 in which the insert 100 is disposed is formed, on one side in the longitudinal direction based on the reaction region through-hole 201, a plurality of first manifold through-holes 210a through which the first or second reaction gas flows in or is discharged are formed, and on the other side in the longitudinal direction based on the reaction region through-hole 201, a plurality of second manifold through-holes 210b through which the first or second reaction gas flows in or is discharged are formed.

Additionally, on the one side of the frame 200, a first coolant manifold through-hole 220a through which coolant flows in or is discharged is formed, and on the other side of the frame 200, a second coolant manifold through-hole 220b through which coolant flows in or is discharged is formed.

Therefore, preferably, on the one side of the frame 200 from the top to the bottom based on the direction of gravity, a first manifold through-hole 210ai through which the first reaction gas flows in, a first coolant manifold through-hole 220a through which the coolant flows in, and a first manifold through-hole 210ao through which the second reaction gas is discharged are formed.

In addition, on the other side of the frame 200 from the top to the bottom based on the direction of gravity, a second manifold through-hole 210bi through which the second reaction gas is discharged, a second coolant manifold through-hole 220b through which the coolant is discharged, and a second manifold through-hole 210bo through which the first reaction gas is discharged are formed.

Meanwhile, on the one surface of the frame 200, a first reaction gas inlet flow channel 230Ai through which the first reaction gas flows is formed between any one of the first manifold through-holes 210a, that is, the first manifold through-hole 210ai through which the first reaction gas flows in, and the reaction region through-hole 201, and a first reaction gas outlet flow channel 230Ao through which the first reaction gas flows is formed between the reaction region through-hole 201 and any one of the second manifold through-holes 210b, that is, the second manifold through-hole 210bo through which the first reaction gas is discharged.

And, on the other surface of the frame 200, a second reaction gas inlet flow channel 230Bi through which the second reaction gas flows is formed between the other one of the second manifold through-holes 210b, that is, the second manifold through-hole 210bi through which the second reaction gas flows in, and the reaction region through-hole 201, and a second reaction gas outlet flow channel 230Bo through which the second reaction gas flows is formed between the reaction region through-hole 201 and the other one of the first manifold through-holes 210a, that is, the first manifold through-hole 210ao through which the second reaction gas is discharged.

In this regard, the first reaction gas inlet flow channel 230Ai, the first reaction gas outlet flow channel 230Ao, the second reaction gas inlet flow channel 230Bi, and the second reaction gas outlet flow channel 230Bo are formed in the form of line-shaped grooves, each having a predetermined depth on the surface of the frame 200. Here, the depths of the first reaction gas inlet flow channel 230Ai, the first reaction gas outlet flow channel 230Ao, the second reaction gas inlet flow channel 230Bi, and the second reaction gas outlet flow channel 230Bo formed in the frame 200 may be formed to be the same depth along the flow direction of the reaction gas or may be formed to have a step along the flow direction of the reaction gas.

And, on the one surface of the frame 200, a first adhesive groove portion 240A is formed in the form of a groove of a closed structure formed to surround the reaction region through-hole 201, the plurality of first manifold through-holes 210a, and the plurality of second manifold through-holes 210b, and on the other surface of the frame 200, a second adhesive groove portion 240B is formed in the form of a groove of a closed structure formed to surround the reaction region through-hole 201, the plurality of first manifold through-holes 210a, and the plurality of second manifold through-holes 210b. Therefore, the adhesive members 400 are disposed in the first adhesive groove portion 240A and the second adhesive groove portion 240B.

At this time, the adhesive members 400 disposed in the first adhesive groove portion 240A and the second adhesive groove portion 240B are placed on the frame or the pair of separators through a separate application or attachment process without being in contact with any one of the membrane electrode assembly 110 and the pair of gas diffusion layers 120A and 120B forming the insert 100.

However, as shown in FIG. 3, when the adhesive member 400 is disposed in the first adhesive groove portion 240A, the adhesive member 400 is disposed except for the regions where the first reaction gas inlet flow channel 230Ai and the first reaction gas outlet flow channel 230Ao are formed, to allow for the smooth flow of the first reaction gas.

Similarly, as shown in FIG. 4A, when the adhesive member 400 is disposed in the second adhesive groove portion 240B, the adhesive member 400 is disposed except for the regions where the second reaction gas inlet flow channel 230Bi and the second reaction gas outlet flow channel 230Bo are formed, to allow for the smooth flow of the second reaction gas.

Additionally, the first adhesive groove portion 240A and the second adhesive groove portion 240B are formed at positions symmetrical to each other based on the thickness direction of the frame 200. In this regard, the first adhesive groove portion 240A and the second adhesive groove portion 240B may be formed to have the same width, or one width may be formed to be relatively smaller than the other width. For example, as shown in FIG. 5, the width of the first adhesive groove portion 240A formed on the one surface of the frame 200 may be formed to be relatively smaller than that of the second adhesive groove portion 240B formed on the other surface of the frame 200.

Meanwhile, the pair of separators 300A, 300B are provided to supply the first reaction gas and the second reaction gas to opposite surfaces of the frame 200, respectively, and to discharge the product water generated by the reaction of the first reaction gas and the second reaction gas, and they are generally manufactured in a structure in which lands that serve as supports and channels (passages) that serve as flow paths for the reaction gas and product water are repeatedly formed in the central region.

In this regard, the pair of separators 300A, 300B are divided into the first separator 300A facing the first gas diffusion layer 120A and the second separator 300B facing the second gas diffusion layer 120B. So, the first separator 300A becomes an anode separator, and the second separator 300B becomes a cathode separator.

Each of the pair of separators 300A, 300B has lands and channels formed in a reaction region in which the insert 100 is disposed, a plurality of third manifold through-holes 310Aa and 310Ba which are formed on one side in the longitudinal direction based on the reaction region and are in communication with the plurality of first manifold through-holes 210a formed in the frame 200, and a plurality of fourth manifold through-holes 310Ab and 310Bb which are formed on the other side in the longitudinal direction based on the reaction region and are in communication with the plurality of second manifold through-holes 210b formed in the frame 200.

Additionally, each of the pair of separators 300A, 300B has a third coolant manifold through-hole 320Aa, 320Ba which is formed on the one side and is in communication with the first coolant manifold through-hole 220a formed in the frame 200 and a fourth coolant manifold through-hole 320Ab, 320Bb which is formed on the other side and is in communication with the second coolant manifold through-hole 220b formed in the frame 200.

Therefore, preferably, on each of the one sides of the pair of separators 300A, 300B from the top to the bottom based on the direction of gravity, the third manifold through-hole 310Aai, 310Bai through which the first reaction gas flows in, the third coolant manifold through-hole 320Aa, 320Ba through which the coolant flows in, and the third manifold through-hole 310Aao, 310Bao through which the second reaction gas is discharged are formed.

Additionally, preferably, on each of the other sides of the pair of separators 300A, 300B from the top to the bottom based on the direction of gravity, the fourth manifold through-hole 310Abi, 310Bbi through which the second reaction gas is discharged, the fourth coolant manifold through-hole 320Ab, 320Bb through which the coolant is discharged, and the fourth manifold through-hole 310Abo, 310Bbo through which the first reaction gas is discharged are formed.

In addition, each of the pair of separators 300A, 300B may be formed flat between the region where each manifold through-hole is formed and the reaction region where the channel and land are formed or may have various forming structures to maintain surface pressure in the corresponding region while facilitating the flow of reaction gas.

For example, the first separator 300A may have first passage tunnels 330Ai, 330Ao, each formed in the form of a tunnel through which the first reaction gas flows by being overlapped with the first reaction gas inlet flow channel 230Ai and the first reaction gas outlet flow channel 230Ao formed on the one surface of the frame 200.

Similarly, the second separator 300B may have second passage tunnels 330Bi, 330Bo, each formed in the form of a tunnel through which the second reaction gas flows by being overlapped with the second reaction gas inlet flow channel 230Bi and the second reaction gas outlet flow channel 230Bo formed on the other surface of the frame 200.

Additionally, the pair of separators 300A and 300B may have a forming structure for adhesion and sealing with the frame 200.

For example, the first separator 300A has a first adhesive forming portion 340A formed toward the one surface of the frame 200 so as to overlap the first adhesive groove portion 240A formed on the one surface of the frame 200. So, the adhesive member 400 is disposed between the first adhesive groove portion 240A and the first adhesive forming portion 340A to tightly adhere the first adhesive groove portion 240A and the first adhesive forming portion 340A, thereby allowing for adhesion and sealing between the one surface of the frame 200 and the first separator 300A.

Similarly, the second separator 300B has a second adhesive forming portion 340B formed toward the other surface of the frame 200 so as to overlap the second adhesive groove portion 240B formed on the other surface of the frame 200. So, the adhesive member 400 is disposed between the second adhesive groove portion 240B and the second adhesive forming portion 340B to tightly adhere the second adhesive groove portion 240B and the second adhesive forming portion 340B, thereby allowing for adhesion and sealing between the other surface of the frame 200 and the second separator 300B.

Meanwhile, it is preferable that each of the first adhesive forming portion 340A and the second adhesive forming portion 340B formed on the first separator 300A and the second separator 300B is formed to have a smaller width than that of each of the first adhesive groove portion 240A and the second adhesive groove portion 240B formed in the frame 200. Therefore, when the first separator 300A and the second separator 300B, which are made of a metal material, expand or contract according to temperature changes and outside temperature changes that occur during the operation of the fuel cell, the amount of change can be sufficiently accommodated within the first adhesive groove portion 240A and the second adhesive groove portion 240B formed in the frame 200.

In addition, it is preferable that the first adhesive forming portion 340A of the first separator 300A and the second adhesive forming portion 340B of the second separator 300B are formed at locations that overlap each other. Therefore, when the frame 200, the first separator 300A, and the second separator 300B are adhered to one another by the adhesive member 400, the adhesive member 400 is disposed at an overlapping location, so that when thermally compressing a corresponding region P1, the region to which heat and pressure are applied can be minimized while making the heat and pressure uniform.

Additionally, the depths of the first reaction gas inlet flow channel 230Ai and the first reaction gas outlet flow channel 230Ao formed on the one surface of the frame 200 are formed deeper than the depth of the first adhesive forming portion 340A formed on the first separator 300A.

Similarly, the depths of the second reaction gas inlet flow channel 230Bi and the second reaction gas outlet flow channel 230Bo formed on the other surface of the frame 200 are formed deeper than the depth of the second adhesive forming portion 340B formed on the second separator 300B.

So, as shown in FIGS. 7A and 7B, even if the first reaction gas inlet flow channel 230Ai, the first reaction gas outlet flow channel 230Ao, the second reaction gas inlet flow channel 230Bi, and the second reaction gas outlet flow channel 230Bo partially overlap the first adhesive forming portion 340A and the second adhesive forming portion 340B, it is possible to avoid the blockage of the first reaction gas inlet flow channel 230Ai, the first reaction gas outlet flow channel 230Ao, the second reaction gas inlet flow channel 230Bi, and the second reaction gas outlet flow channel 230Bo.

Meanwhile, any one of the first adhesive forming portion 340A of the first separator 300A and the second adhesive forming portion 340B of the second separator 300B may be provided with a gasket 500 applied to the opposite surface to the surface on which the adhesive member 400 is applied, to form an airtight line for the sealing of the coolant.

For example, in this embodiment, the gasket 500 may be formed on the second adhesive forming portion 340B of the second separator 300B.

Thus, the first adhesive forming portion 340A formed on the reaction surface of the first separator 300A is adhered to the one surface of the frame 200 by the adhesive member 400, and neither the adhesive member nor the gasket is disposed on a cooling surface of the first separator 300A. And, the second adhesive forming portion 340B formed on the reaction surface of the second separator 300B is adhered to the other surface of the frame 200 by the adhesive member 400, and the gasket 500 is disposed on a cooling surface of the second separator 300B, so that airtightness of the coolant can be maintained by the gasket 500 and the adjacent first separator 300A in the unit cell when forming a fuel cell stack.

Meanwhile, each of the pair of separators 300A, 300B is provided with a coolant inlet flow region 350Ai, 350Bi through which coolant flows between the first coolant manifold through-hole 310Aa, 310Ba and the reaction region through-hole 201 and with a coolant outlet flow region 350Ao, 350Bo through which coolant flows between the second coolant manifold through-hole 310Ab, 310Bb and the reaction region through-hole 201.

In this regard, as shown in FIG. 6, the pair of separators 300A, 300B are respectively formed to be in contact with the opposite surfaces of the insert 100 in the regions where the coolant inlet flow regions 350Ai, 350Bi and the coolant outlet flow regions 350Ao, 350Bo are formed. So, when constructing a fuel cell stack, the first separator 300A and the second separator 300B of adjacent unit cells are spaced apart by a predetermined distance, and the coolant flows through this space between them.

Meanwhile, it is preferable that the size of the periphery of the frame 200 is the same as or larger than those of the pair of separators 300A and 300B as shown in FIG. 5. Preferably, it is more acceptable to form the periphery of the frame 200 to have a size larger than those of the pair of separators 300A and 300B. Therefore, as the ends of the peripheries of the first separator 300A and the second separator 300B are disposed further on the inside of the unit cell than the end of the periphery of the insert 100 at the periphery of the unit cell, it is possible to fundamentally prevent an electrical short from occurring due to contact between the first separator 300A and the second separator 300B when their peripheries are bent.

Meanwhile, in embodiments of the present disclosure, in order to prevent the gasket 500 from being damaged or deformed when the pair of separators 300A, 300B are adhered to the opposite surfaces of the frame 200 by thermocompressing the adhesive member 400, the placement location of the adhesive member 400 may be different from the location where the gasket 500 is formed.

As shown in FIGS. 8A and 8B, although the formation locations of the first adhesive forming portion 340A formed on the first separator 300A and the second adhesive forming portion 340B formed on the second separator 300B overlap each other, the locations where the gasket 500 and the adhesive member 400 are adhered while being disposed on the opposite surfaces of the second adhesive forming portion 340B of the second separator 300B may be offset from each other by forming the width of the first adhesive forming portion 340A formed on the first separator 300A to be relatively larger than that of the second adhesive forming portion 340B formed on the second separator 300B. Thus, the gasket 500 can be prevented from being damaged or deformed by heat and pressure by disposing the gasket 500 at a point away from a region P2 to which surface pressure is applied during thermocompression of the adhesive member 400.

Although embodiments of the present disclosure have been described with reference to the accompanying drawings and the above-described preferred embodiments, the embodiments of the present disclosure are not limited thereto. Accordingly, those of ordinary skill in the art would make various changes and modifications of the embodiments of the present disclosure without departing from the scope of the technical idea of the claims to be described later.

The following reference identifiers may be used in connection with the drawings to describe various features of embodiments of the present invention.
100: Insert
110: Membrane electrode assembly
120A, 120B: Gas diffusion layers
200: Frame
201: Reaction region through-hole
202: Joint portion
210a: First manifold through-hole
210b: Second manifold through-hole
220a: First coolant manifold through-hole
220b: Second coolant manifold through-hole
230Ai: First reaction gas inlet flow channel
230Ao: First reaction gas outlet flow channel
230Bi: Second reaction gas inlet flow channel
230Bo: Second reaction gas outlet flow channel
240A: First adhesive groove portion
240B: Second adhesive groove portion
300A: First separator
310a: First manifold through-hole
310Ab: Second manifold through-hole
320Aa: Third coolant manifold through-hole
320Ab: Fourth coolant manifold through-hole
330A: First passage tunnel
340A: First adhesive forming portion
350Ai: Coolant inlet flow region
350Ao: Coolant outlet flow region
300B: Second separator
310Ba: First manifold through-hole
310Bb: Second manifold through-hole
320Ba: Third coolant manifold through-hole
320Bb: Fourth coolant manifold through-hole
330B: Second passage tunnel
340B: Second adhesive forming portion
350Bi: Coolant inlet flow region
350Bo: Coolant outlet flow region
400: Adhesive member
500: Gasket

What is claimed is:

1. An integrated unit cell for a fuel cell stack, the integrated unit cell comprising:
an insert constructed with a membrane electrode assembly and a pair of gas diffusion layers disposed on opposite surfaces of the membrane electrode assembly;
a frame having a form of a sheet, the frame being disposed to surround a periphery of the insert in an outer boundary region of the insert and joined to any one of opposite surfaces of the periphery of the insert by a first adhesive member at an interface thereof; and
a pair of separators disposed on opposite surfaces of the frame, respectively, and joined to the opposite surfaces of the frame by second adhesive members.

2. The integrated unit cell of claim 1, wherein a joint portion to which any one of the opposite surfaces of the insert is joined is defined by a reaction region through-hole disposed in the frame, in which the insert is disposed, and by a step portion along an inner peripheral surface of the reaction region through-hole to have a level difference from a surface.

3. The integrated unit cell of claim 2, wherein a first gas diffusion layer of the pair of gas diffusion layers of the insert has a same size as the membrane electrode assembly and a second gas diffusion layer of the pair of gas diffusion layers is smaller than the membrane electrode assembly such that a periphery of the membrane electrode assembly is exposed and the exposed periphery is joined to the joint portion by the first adhesive member.

4. The integrated unit cell of claim 1, further comprising:
a reaction region through-hole disposed in a center of the frame, wherein the insert is disposed in the reaction region through-hole;
a plurality of first manifold through-holes disposed on a first side of the frame, wherein the plurality of first manifold through-holes are configured to allow a first reaction gas or a second reaction gas to flow in or be discharged from;
a plurality of second manifold through-holes disposed on a second side of the frame, wherein the plurality of second manifold through-holes are configured to allow the first reaction gas or the second reaction gas to flow in or be discharged from;
a first reaction gas inlet flow channel disposed on a first surface of the frame between any one of the first manifold through-holes and the reaction region through-hole, wherein the first reaction gas inlet flow channel is configured to allow the first reaction gas to flow therethrough;
a first reaction gas outlet flow channel disposed on the first surface of the frame between the reaction region through-hole and any one of the second manifold through-holes, wherein the first reaction gas outlet flow channel is configured to allow the first reaction gas to flow therethrough;
a second reaction gas inlet flow channel disposed on a second surface of the frame between another of the second manifold through-holes and the reaction region through-hole, wherein the second reaction gas inlet flow channel is configured to allow the second reaction gas to flow therethrough; and
a second reaction gas outlet flow channel disposed on the second surface of the frame between the reaction region through-hole and another of the first manifold through-holes, wherein the second reaction gas outlet flow channel is configured to allow the second reaction gas to flow therethrough.

5. The integrated unit cell of claim 4, wherein each of the pair of separators comprises:
a plurality of third manifold through-holes disposed on a first side and in communication with the plurality of first manifold through-holes; and
a plurality of fourth manifold through-holes disposed on a second side and in communication with the second manifold through-holes.

6. The integrated unit cell of claim 5, wherein:
the pair of separators comprises a first separator joined to a first surface of the frame and a second separator joined to a second surface of the frame;
the first separator comprises first passage tunnels, each having a form of a tunnel through which the first reaction gas flows by being overlapped with the first reaction gas inlet flow channel and the first reaction gas outlet flow channel; and
the second separator comprises second passage tunnels, each having the form of the tunnel through which the second reaction gas flows by being overlapped with the second reaction gas inlet flow channel and the second reaction gas outlet flow channel.

7. The integrated unit cell of claim 5, wherein:
a first coolant manifold through-hole is disposed on the first side of the frame, wherein the first coolant manifold through-hole is configured to allow a coolant to flow in or be discharged;
a second coolant manifold through-hole is disposed on the second side of the frame, wherein the second coolant manifold through-hole is configured to allow the coolant to flow in or be discharged; and
each of the pair of separators comprises:
a third coolant manifold through-hole disposed on a first side and in communication with the first coolant manifold through-holes; and
a fourth coolant manifold through-hole disposed on a second side and in communication with the second coolant manifold through-holes.

8. The integrated unit cell of claim 7, further comprising:
a coolant inlet flow region disposed in the pair of separators between the first coolant manifold through-hole and the reaction region through-hole, wherein the coolant inlet flow region is configured to allow the coolant to flow therethrough; and
a coolant outlet flow region disposed in the pair of separators between the reaction region through-hole and the second coolant manifold through-holes, wherein the coolant inlet flow region is configured to allow the coolant to flow therethrough.

9. The integrated unit cell of claim 8, wherein the pair of separators are disposed such that regions where the coolant inlet flow region and the coolant outlet flow region are disposed are in contact with opposite surfaces of the insert.

10. The integrated unit cell of claim 4, further comprising:
a first adhesive groove portion disposed on a first surface of the frame in a form of a groove of a closed structure surrounding the reaction region through-hole, the plurality of first manifold through-holes, and the plurality of second manifold through-holes;
a second adhesive groove portion disposed on a second surface of the frame in the form of the groove of the closed structure surrounding the reaction region through-hole, the plurality of first manifold through-holes, and the plurality of second manifold through-holes; and
the second adhesive members disposed in the first adhesive groove portion and the second adhesive groove portion.

11. The integrated unit cell of claim 10, wherein the first adhesive groove portion and the second adhesive groove portion are disposed at locations symmetrical to each other based on a thickness direction of the frame.

12. The integrated unit cell of claim 10, wherein the second adhesive members disposed in the first adhesive groove portion and the second adhesive groove portion do not contact the insert and are disposed on the frame or the pair of separators.

13. The integrated unit cell of claim 10, wherein:
the pair of separators comprises a first separator joined to the first surface of the frame and a second separator joined to the second surface of the frame;
the first separator comprises a first adhesive forming portion disposed toward the frame so as to overlap the first adhesive groove portion such that adherence and sealing between the first adhesive forming portion and the first adhesive groove portion are achieved by one of the second adhesive members; and
the second separator comprises a second adhesive forming portion disposed toward the frame so as to overlap the second adhesive groove portion such that adherence and sealing between the second adhesive forming portion and the second adhesive groove portion are achieved by another one of the second adhesive members.

14. The integrated unit cell of claim 13, wherein:
depths of the first reaction gas inlet flow channel and the first reaction gas outlet flow channel disposed on the first surface of the frame are deeper than a depth of the first adhesive forming portion disposed on the first separator; and
depths of the second reaction gas inlet flow channel and the second reaction gas outlet flow channel disposed on the second surface of the frame are deeper than a depth of the second adhesive forming portion disposed on the second separator.

15. The integrated unit cell of claim 13, wherein the first adhesive forming portion and the second adhesive forming portion have widths smaller than widths of the first adhesive groove portion and the second adhesive groove portion, respectively.

16. The integrated unit cell of claim 13, wherein the first adhesive forming portion of the first separator and the second adhesive forming portion of the second separator are disposed at locations that overlap each other.

17. The integrated unit cell of claim 13, wherein the first adhesive forming portion of the first separator or the second adhesive forming portion of the second separator is provided with a gasket applied to an opposite surface to the surface on which the second adhesive member is disposed to form an airtight line for sealing of a coolant.

18. The integrated unit cell of claim 1, wherein a size of the periphery of the frame is greater than or equal to a size of the pair of separators.

19. The integrated unit cell of claim 1, wherein the frame comprises engineering plastic or super engineering plastic with a thermal expansion coefficient of 40×10⁻⁶/° C. or less.

20. A method of forming an integrated unit cell for a fuel cell stack, the method comprising:
constructing an insert with a membrane electrode assembly and a pair of gas diffusion layers disposed on opposite surfaces of the membrane electrode assembly;
forming a frame having a form of a sheet, the frame being disposed to surround a periphery of the insert in an outer boundary region of the insert and joined to any one of opposite surfaces of the periphery of the insert by a first adhesive member at an interface thereof, wherein forming the frame comprises forming the frame into a three-dimensional structure by injection molding, injection/compression hybrid molding, compression molding, or 3D printing forming; and
disposing a pair of separators on opposite surfaces of the frame, respectively, and joined to the opposite surfaces of the frame by second adhesive members.
